(19) United States
(12) Patent Application Publication
(10) Pub. No.: US 2008/0244108 A1
(43) Pub. Date: Oct. 2, 2008

(54) PER-PORT UNIVERSAL SERIAL BUS DISABLE

(76) Inventors: Darren L. Abramson, Folsom, CA (US); Jeffrey T. Brown, Folsom, CA (US); Robert W. Strong, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/693,569

(22) Filed: Mar. 29, 2007

(51) Int. Cl. G06F 3/00

(52) U.S. Cl. 710/16

(57) ABSTRACT

A device and system are disclosed. In one embodiment, the device includes a register to store a universal serial bus (USB) port disable bit for an individual USB port. The device also includes a USB individual port disable unit that is capable of reading the USB port disable bit and disabling the individual USB port when the bit is set.

### FIELD OF THE INVENTION

The invention relates to a universal serial bus. More specifically, the invention relates to disabling a universal serial bus port.

### BACKGROUND OF THE INVENTION

As computers become ubiquitous throughout society, computer platforms are coming under attack from ever-increasing security threats. External Universal Serial Bus (USB) ports allow any USB device to plug into the platform. For example, an unwanted USB storage device can connect to the platform through the external USB port and download sensitive data from the system in short time. Additionally, the same unwanted USB storage device can upload a virus or worm stored on it into the computer platform.

For computer systems that require significant security protection against these threats, many companies pour an epoxy into the external USB ports to effectively permanently disable the ports. Another solution is to disable the entire USB subsystem, but this would have the negative side effect of disabling any platform-internal USB devices that do not connect through an external port. Currently, there is no lockable, BIOS-based method to manage the visibility of individual USB ports to software via hardware methods. Thus, these extreme, and seemingly permanent measures are commonplace today to maintain platform security.

### BRIEF DESCRIPTION OF THE DRAWINGS

The present invention is illustrated by way of example and is not limited by the figures of the accompanying drawings, in which like references indicate similar elements, and in which:

FIG. 1 describes one embodiment of a device and system for disabling USB ports on a per-port basis.

FIG. 2 is a flow diagram of one embodiment of a process to disable an individual USB port.

### DETAILED DESCRIPTION OF THE INVENTION

Embodiments of a device and system for disabling an individual universal serial bus (USB) port are described. In the following description, numerous specific details are set forth. In other instances, well-known elements, specifications, and protocols have not been discussed in detail in order to avoid obscuring the present invention.

References to “one embodiment”, “an embodiment”, “example embodiment”, “various embodiments”, “some embodiments”, “many embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

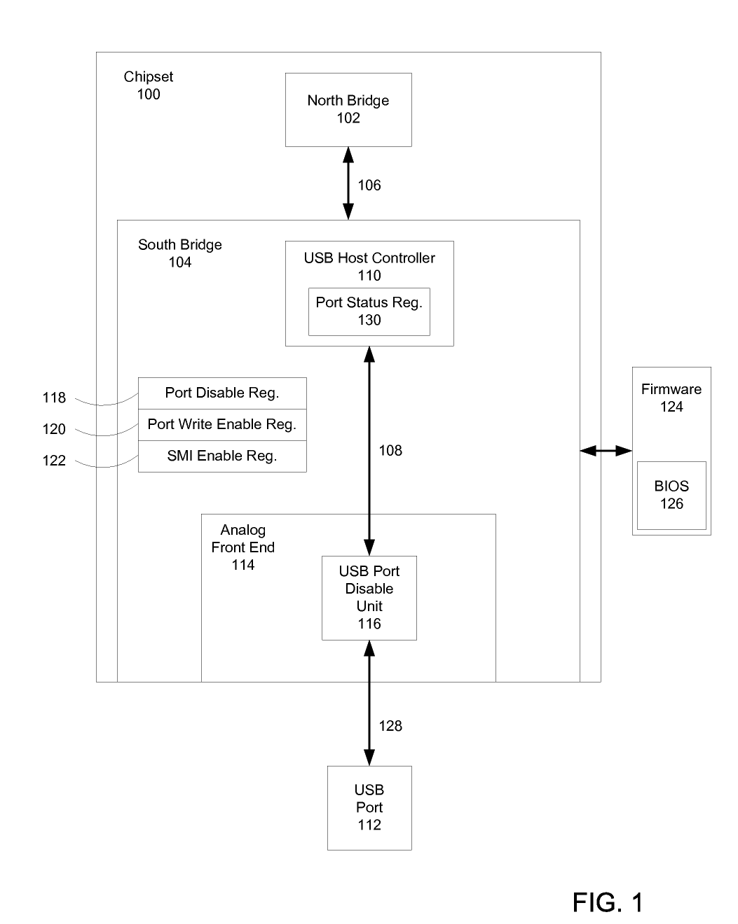

FIG. 1 describes one embodiment of a device and system for disabling USB ports on a per-port basis. In many embodiments, chipset 100 resides on a computer system. In many embodiments, the computer system may include a processor, system memory, and a processor-memory interconnect for communication between different agents coupled to interconnect, such as the processor and system memory. Chipset 100 may help with routing the communication between these different agents. The processor, system memory, and processor-memory interconnect are not shown in FIG. 1. Chipset 100 includes a north bridge 102. In some embodiments, north bridge 102 has a system memory controller located within it for communicating with system memory.

In many embodiments, chipset 100 also includes a south bridge 104. In some embodiments, south bridge 104 is coupled to north bridge 102 by a hub-link interconnect 106. In other embodiments, interconnect 106 is another type of interconnect capable of high-speed data transfer between the north and south bridges. South bridge 104 controls the input/output (I/O) communication between the chipset and many I/O devices present within the system. In many embodiments, south bridge 104 is coupled to one or more I/O interconnects. Additionally, one or more I/O devices present within the system are coupled to the one or more interconnects. Communication between the south bridge 104 and a given I/O device coupled to one of the interconnects is controlled by an interconnect host controller. In some embodiments, an interconnect host controller present in the system is located within the south bridge 104.

In many embodiments, one particular interconnect present within the system is a USB interconnect. The USB interconnect may be a USB 1.1 interconnect, a USB 2.0 interconnect, or any other operable version of the USB interconnect specification in different embodiments. The details regarding the functionality of the USB interconnect, one or more host controllers, hubs, and ports can be found in the current USB Specification (the 2.0 revision of the specification was released on Apr. 27, 2000 and can be found on the USB organization's website). In many embodiments, the USB interconnect includes two portions, an internal portion 108 of the interconnect that is routed from a USB host controller 110 located within the south bridge 104 to an analog front end (AFE) 114 also located within the south bridge 104, and an external portion 128 that is routed from the AFE 114 in the south bridge to a USB port 112 external to the south bridge 104. In some embodiments, signals transmitted across the internal USB interconnect portion 108 may include digital signals and signals transmitted across the external USB interconnect portion 128 may include analog signals. In some embodiments, the AFE 114 performs digital-to-analog and analog-to-digital conversions of signals passing from one portion of the USB interconnect to the other portion

The USB interconnect is referred to as a tiered star interconnect. There may be multiple layers of the interconnect including the USB host controller 110 as well as one or more USB hubs and USB devices located at one or more levels down from the USB host controller 110. The USB interconnect 108 transfers control, address, and data signals, as well as power, over a four-wire cable. The signaling occurs over two-wires on each point-to-point segment. The USB interconnect branches out at the AFE 114 so multiple ports may be connected to the AFE 114.

In many embodiments, a USB individual port disable unit 116 is coupled to the USB interconnect. In some embodiments, the USB port disable unit 116 is located within the AFE 114. In other embodiments, the USB port disable unit 116 is located within the USB host controller 110. In yet other embodiments, the USB port disable unit 116 is located at another location between the USB host controller 110 and the AFE 114. The example embodiment described in FIG. 1 shows an embodiment where the USB port disable unit 116 is located within the AFE 114. In many embodiments, the USB port disable unit 116 is coupled to the USB interconnect at a location prior to when the USB interconnect branches into multiple interconnects leading to multiple USB ports.

In many embodiments, the USB port disable unit 116 includes logic (i.e. hardware and/or software logic) to prevent communication between a physical USB device and a software layer above it that resides in an operating system, virtual machine manager, or similar software environment. The logic reads transactions being transmitted across the USB interconnect both downstream (originating from the USB host controller 110) and upstream (originating from a USB hub or a USB port coupled to the USB interconnect). In many embodiments, the USB port disable unit 116 additionally includes logic to intercept transactions being transmitted across the USB interconnect. Intercepting a transaction encompasses stopping the transaction from proceeding to its destination on the interconnect.

USB host controller 110 may be queried by a software application running on the system to provide the current status of a given port by the USB command Get Port Status. The way in which a software application can determine that a USB device is connected to a port is to read a USB port status register 130. USB port status registers for each USB port are located within the USB host controller 110. The USB Specification describes all the bit fields in a USB port status register. The USB host controller 110 returns the current status of the port in a current port status field within the specific USB port status register 130. Bit 0 in the current port status field is the current connect status (0=no device present on the port, 1=a device is present on the port). Bit 1 in the current port status field is the port enabled/disabled field (0=port is disabled, 1=port is enabled). The USB host controller determines these two status bits based on the signals or lack thereof, returning from the port to the USB host controller. The specific methodology for a USB host controller to determine whether a device is present on a port and whether a port is enabled is discussed in detail in the USB Specification.

To effectively disable an individual USB port utilizing an internal logic process, one or more of the following scenarios would take place. The USB host controller may not see that a device is presently connected to the individual USB port. The USB host controller may not see that the individual USB port is enabled. The individual USB port must not receive a USB reset signal from the USB host controller. And, the individual USB port must not receive a USB test mode signal from the USB host controller. In many embodiments, depending on the state of the computer system, one or more of these scenarios would be implemented to effectively disable an individual USB port utilizing an internal logic process.

Returning to FIG. 1, in a normal USB environment, if a device is connected to USB port 112, the USB port 112 would send a signal to the USB host controller 110 informing the controller that a device is currently connected to USB port 112. This would tell the USB host controller 110 that a device is present. The specific electrical signal utilized by a USB port to inform a USB host controller that a device is present is described in detail in the USB Specification.

Alternatively, in embodiments utilizing the USB port disable unit 116, the signal, sent from the USB port 112 to the USB host controller 110, informing the controller that a USB device being present and connected to USB port 112 is intercepted by the USB port disable unit 116. In the place of this signal, the USB port disable unit 116 sends a signal (or a the lack of a signal) to inform the USB host controller 110 that there is no device present on the USB port 112, a “no device is present” signal. When the USB host controller 110 receives this signal, the USB host controller 110 assumes that no device is connected to the USB port 112 and sets the current connect status bit in the port status field for USB port 112 to “0.” Thus, when software queries the USB host controller 110 regarding the status of USB port 112, the software will receive a “no device is present” result. Therefore, even when a device is present and connected to the USB port 112, in these embodiments, the USB port disable unit 116 will force the USB host controller 110 to report that a device is not present, which will, in turn, force the originator of the query to report that a device is not present.

Furthermore, in a normal USB environment, if the USB port 112 is enabled and functioning correctly, the USB port 112 would send a signal to the USB host controller 110 informing the controller that the USB port 112 is enabled. This would tell the USB Controller 110 that the port is enabled. The specific electrical signal utilized by a USB port to inform a USB host controller that the port is enabled is described in detail in the USB Specification.

In many embodiments, there is a port enable state per USB port maintained by the USB host controller 110 as part of a port status and control register.

Alternatively, in embodiments utilizing the USB port disable unit 116, the signal, sent from the USB port 112 to the USB host controller 110, informing the controller that USB port 112 is enabled is intercepted by the USB port disable unit 116. In the place of this signal, the USB port disable unit 116 sends a signal informing the USB host controller that USB port 112 is disabled, a “port is disabled” signal. When the USB host controller 110 receives this signal, the controller assumes that USB port 112 is disabled and sets the port enabled/disabled bit in the port status field for USB port 112 to “0.” Thus, when software queries the USB host controller 110 regarding the status of USB port 112, the software will receive a “port is disabled” result.

Alternatively, in other embodiments, the USB port disable unit 116 is located within the USB host controller 110 coupled to logic within the controller that sets and clears individual bits within each USB port status register (such as register 130). In some of these embodiments, the USB host controller 110 is aware of the an individual USB port being enabled (“port is enabled”) and is aware of a device being connected to the port (“device is present”), but the USB port disable unit 116 does not allow the USB host controller 110 to set these respective bits within the USB port status register. Thus, the USB port disable unit 116 forces the current connect status bit and the port enabled/disabled bit in the USB port status register to zero (“0”).

In all embodiments, software running on the platform trying to determine the status of a USB port using the get port status command will receive zeros in the current connect status bit and the port enable/disable bit fields if the USB port disable unit 116 is disabling the USB port. Therefore, regardless of what is connected to the USB port, there will not be any device visible to software and the port will look disabled to software.

Additionally, in many embodiments, software may attempt to reset a USB port to try to get the port functional again. The reset signal sent from the USB host controller to a port is described in detail in the USB Specification. To eliminate the port performing a reset, in many embodiments, the USB port disable unit 116 intercepts a reset signal transmitted from the USB host controller 110 to the port being targeted for disabling (USB port 112 in this example). Thus, the USB port disable unit 116 does not allow a reset signal to reach USB port 112. As a result, USB port 112 will not reset as long as the port is still targeted for disabling.

Software may also attempt to put a USB port into a test mode that would not necessarily require a reset in many embodiments. Test mode signals sent from the USB host controller to a port are described in detail in the USB specification. To eliminate the port entering a test mode, in many embodiments, the USB port disable unit 116 intercepts one or more test mode signals sent from the USB host controller 110 to the port being targeted for test mode purposes (USB port 112 in this example). The USB port disable unit does not allow the test mode signal to reach the USB port. As a result, USB port 112 will not enter a test mode as long as the port is still targeted for disabling.

The USB port disable unit 116 may disable any USB port coupled to the USB interconnect. In some embodiments, the USB individual port disable register 118 stores one bit per USB port present within the system. Thus, in one embodiment, if a USB port disable bit corresponding to a USB port is set (i.e. has a “1” in the bit field), then that corresponding USB port is disabled. Alternatively, if the USB port disable bit corresponding to the USB port is cleared (i.e. has a “0” in the bit field), then that corresponding USB port is not disabled. “Disabled” refers to logic within the USB port disable unit 116 disabling the port through processes described above.

Additionally, a USB port write enable register 120 stores a USB port write enable bit for each USB individual port disable bit. In many embodiments, the USB port write enable bit determines per port whether writes are allowed to the corresponding USB port disable bit (for each USB port) stored in the USB port disable register 118. In one embodiment, if the write enable bit, corresponding to a specific USB individual port disable bit, is set, then software running on the system can modify the USB port disable bit. If the write enable bit is cleared, then software running on the system cannot modify the state of the corresponding USB port disable bit.

A system management interrupt (SMI) enable register 122 stores a write enable SMI enable bit. In many embodiments, when the write enable SMI enable bit is set, an SMI is generated if software running on the system attempts to enable or re-enable one or more USB port write enable bits. Thus, the SMI will notify the system that software is attempting to gain access to the USB port disable unit functionality. In other embodiments, there is a write enable SMI enable bit for each USB port write enable bit, thus, in these embodiments, the SMI can be specific per port to notify the system that software is attempting to gain access to a specific port's enable/disable functionality in the USB port disable unit. In some embodiments, in response to the SMI, an SMI handler may choose to attempt to detect the device inserted into the port. Additionally, the handler may also choose whether or not to allow it to function based on the type of device.

The USB individual port disable register 118, USB port write enable register 120, and SMI enable register 122 may be located anywhere within the chipset in different embodiments. In many embodiments, these registers are located within the south bridge 104. In different embodiments, the registers are located within the USB host controller 110 or the USB port disable unit 116 (these embodiments are not shown).

In many embodiments, a firmware device 124 storing a basic input/output system (BIOS) 126 is coupled to the south bridge 104 of the chipset 100. In many embodiments, during system boot, the BIOS 126 assumes control of any USB port disable policy. Upon system boot the BIOS 126 would comprehend which, if any, USB ports are available, and how those ports are connected to one or more USB controllers in the system. Once the BIOS determines how the system may be configured, then the BIOS determines the configuration for the appropriate USB port disable bit, the appropriate USB port write enable bits, and the write enable SMI enable bit.

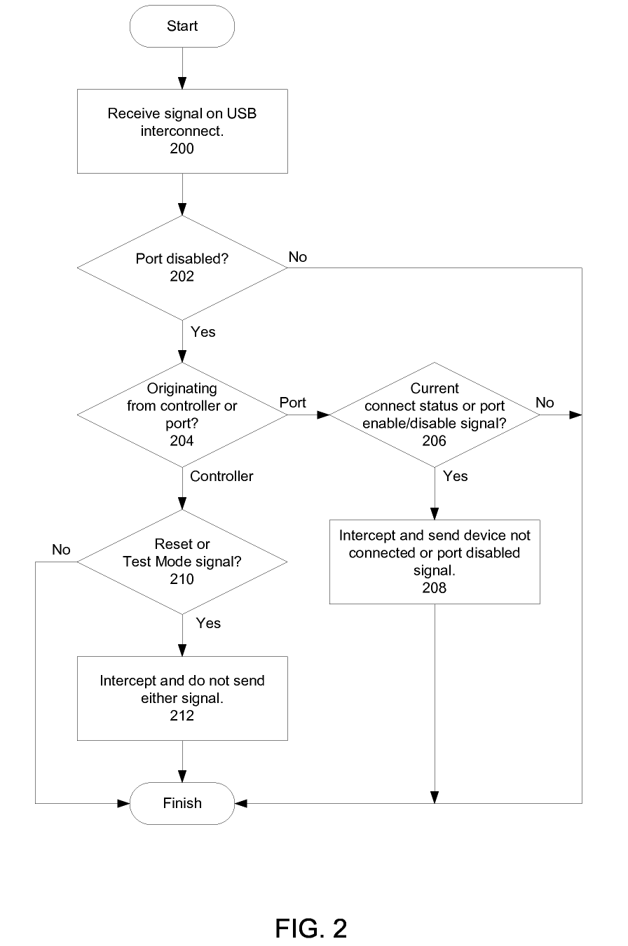

FIG. 2 is a flow diagram of one embodiment of a process to disable an individual USB port. The process is performed by processing logic that may comprise hardware (circuitry, dedicated logic, etc.), software (such as is run on a general purpose computer system or a dedicated machine), or a combination of both. Referring to FIG. 2, the process begins by processing logic receiving a signal on a USB interconnect (processing block 200). The process continues with processing logic determining if the port that the signal corresponds to is disabled (processing block 202). If the port is not disabled then the process is finished.

Otherwise, if the port is disabled, then processing logic determines if the signal originated from the USB host controller or the USB port (processing block 204). If the signal originated at the USB port, then processing logic checks to see if the signal is attempting to inform the USB host controller of the current connect status or port enable/disable information corresponding to the USB port (processing block 206). If the signal is not related to one of those signals then the process is finished. If the signal is related to one of those signals, then processing logic intercepts the signal and sends the respective “device not connected” signal or the “port disabled” signal to the USB host controller (processing block 208) and the process is finished.

If the signal is originating from the USB host controller, then processing logic checks to see if the signal is attempting to reset the USB port or put the USB port into a Test Mode (processing block 210). If the signal is not related to one of those signals then the process is finished. If the signal is related to one of those signals, then processing logic intercepts the signal and does not send either signal to the USB port and the process is finished.

Thus, embodiments of a device and system for disabling an individual USB port are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A device, comprising:
a first register to store a universal serial bus (USB) port disable bit for an individual USB port;
a USB individual port disable unit to
read the USB port disable bit; and
disable the individual USB port when the bit is set.

2. The device of claim 1, wherein the USB individual port disable unit is further operable to:
intercept a current connect status signal sent from the individual USB port to a USB host controller; and
transmit a device is not detected signal the USB host controller in place of the intercepted current connect status signal to inform the USB host controller that no device is present.

3. The device of claim 2, wherein the USB individual port disable unit is further operable to:
intercept a port enabled/disabled signal sent from the individual USB port to the USB host controller; and
transmit a port is disabled signal to the USB host controller in place of the intercepted port enabled/disabled signal to inform the USB host controller that the port is disabled.

4. The device of claim 3, wherein the USB individual port disable unit is further operable to:
intercept a reset signal sent from the USB host controller to the individual USB port.

5. The device of claim 4, wherein the USB individual port disable unit is further operable to:
intercept a test mode signal sent from the USB host controller to the individual USB port.

6. The device of claim 1, further comprising a second register to store a USB port write enable bit for the individual USB port, wherein,
when the write enable bit is set, writes to the USB port disable bit are supported; and
when the write enable bit is cleared, software cannot modify the state of the USB port disable bit.

7. The device of claim 6, wherein the second register is further operable to store a write enable system management interrupt (SMI) enable bit for the individual USB port, wherein,
when the write enable SMI enable bit is set, a SMI is generated if software attempts to set the write enable bit.

8. The device of claim 1, wherein the USB individual port disable unit is further operable to force a current connect status bit and a port enabled/disabled bit in a USB port status register to zero.

9. A system, comprising:
a universal serial bus (USB) interconnect;
an individual USB port coupled to the USB interconnect;
a USB host controller coupled to the USB interconnect;
a first register to store a USB port disable bit for the individual USB port;
a USB individual port disable unit, coupled to the USB interconnect, operable to
read the USB port disable bit; and
disable the individual USB port when the bit is set; and
a second register to store a USB port write enable bit.

10. The system of claim 9, wherein the USB individual port disable unit is further operable to:
intercept a current connect status signal sent from the individual USB port to a USB host controller; and
transmit a device is not detected signal the USB host controller in place of the intercepted current connect status signal to inform the USB host controller that no device is present.

11. The system of claim 10, wherein the USB individual port disable unit is further operable to:
intercept a port enabled/disabled signal sent from the individual USB port to the USB host controller; and
transmit a port is disabled signal to the USB host controller in place of the intercepted port enabled/disabled signal to inform the USB host controller that the port is disabled.

12. The system of claim 11, wherein the USB individual port disable unit is further operable to:
intercept a reset signal sent from the USB host controller to the individual USB port.

13. The system of claim 12, wherein the USB individual port disable unit is further operable to:
intercept a test mode signal sent from the USB host controller to the individual USB port.

13. The system of claim 8, wherein the USB individual port disable unit is further operable to:
allow writes to the USB port disable bit when the write enable bit in the second register is set; and
not allow writes to the USB port disable bit when the write enable bit in the second register is cleared.

14. The system of claim 13, wherein the second register is further operable to store a write enable system management interrupt (SMI) enable bit for the individual USB port, wherein,
when the write enable SMI enable bit is set, a SMI is generated if software attempts to set the write enable bit for the individual USB port.

15. The system of claim 9, wherein the USB individual port disable unit is further operable to force a current connect status bit and a port enabled/disabled bit in a USB port status register to zero.
